(19) United States
(12) Patent Application Publication
(10) Pub. No.: US 2013/0024241 A1
(43) Pub. Date: Jan. 24, 2013

(54) METHODS AND SYSTEMS FOR COLLECTING AND PROVIDING INFORMATION REGARDING COMPANY CULTURE

(71) Applicants: Arthur L. P. Papas, Weston, MA (US); Philip Costa, Cambridge, MA (US); Joseph B. Zeff, Cambridge, MA (US); Matthew Moore, Somerville, MA (US); Philip C. Siebert, Boston, MA (US); William M. Kimeria, Arlington, MA (US); Bryan J. Roy, Boston, MA (US); James P. Dowd, Charlestown, MA (US)

(72) Inventors: Arthur L. P. Papas, Weston, MA (US); Philip Costa, Cambridge, MA (US); Joseph B. Zeff, Cambridge, MA (US); Matthew Moore, Somerville, MA (US); Philip C. Siebert, Boston, MA (US); William M. Kimeria, Arlington, MA (US); Bryan J. Roy, Boston, MA (US); James P. Dowd, Charlestown, MA (US)

(73) Assignee: Bullhorn, Inc., Boston, MA (US)

(21) Appl. No.: 13/188,080

(22) Filed: Jul. 21, 2011

(51) Int. Cl. G06Q 10/00

(52) U.S. Cl. 705/7.32

(57) ABSTRACT

Aspects of the present invention provide an efficient way for the job seeker to search for a company that fits the seeker's desired cultural traits by enabling the job seeker to identify key traits sought after in a prospective employer, and to use those traits to focus the job search. Thus, a job seeker is able to use a formal framework for assessing a company culture, can have access to a more-comprehensive listing of companies that meet certain criteria, can identify traits that are the most and least relevant to a company's culture, and can, as a result, see relative rankings of companies along various cultural dimensions.

### BACKGROUND OF THE INVENTION

Online job boards have become a dominant source for people to find work, with more than one-quarter of respondents using online job boards to secure their most recent job (see Kelly Global Workforce Index). Even though online job boards are enabling more and more job seekers to find jobs (and companies to find talent), these online channels have not led to greater satisfaction. Consider the following facts. 70% of applicants and 28% of hiring managers indicate they are dissatisfied with the hiring process (see Staffing.org). 50% of managers and new hires later regret their decision (see The Recruiting Roundtable). Perhaps most telling of all, a stunning 46% of new hires leave their jobs within the first year (see eBullpen, LLC) and 50% of current employees are actively seeking or are planning to seek new employment (see Deloitte). Thus, while current online job boards enable “transactions” between labor market “buyers” (companies) and “sellers” (job seekers), too frequently at least one side of the transactions is left unsatisfied.

Having the right talent in place can be the most important ingredient for business success; in the words of a New York Times bestseller, “Who is where the magic begins, or where the problems start.” See Geoff Smart and Randy Street, Who: The A Method For Hiring, ghSmart & Company, Inc., 2008, published by Ballantine Books. Why do so many new hires not work out? Certainly, there are many contributing factors, and no two situations are identical, but based on research and over a decade of experience in helping recruiters fill hundreds of thousands of jobs, it is clear that very often there is a lack of a cultural fit between the new hire (employee) and the organization (employer).

Many companies go to great lengths during the interview process to measure a candidate's ability to function within a particular environment. In addition to measuring knowledge, skills, and abilities, recruiters and hiring managers evaluate a candidate's work style, ability to collaborate with others, and even his/her professional values. For a job seeker, however, assessing fit with a prospective employer can be extremely difficult. First, companies actively manage their “employment brands” in an effort to project a particular image of the firm. Thus, much of the information available to job seekers is generated with a deliberate message. Second, the process of identifying and evaluating job opportunities typically revolves around objective criteria. For example, on most job boards job seekers can identify job opportunities based on job titles and descriptions, educational and skill requirements, and compensation. Job seekers can also search for prospective employers based on “firmographic” information, such as for example, company size, industry, and location. None of this information, however, provides insight into what goes on inside the walls of a given company, or what the experience of working for the company is like.

Some existing online job boards have attempted to address this problem, but fail for a variety of reasons. One approach involves collecting company reviews and ratings from consumers, i.e., community-generated information. One example is Glassdoor.com, which is emblematic of the community-generated content that is typically available. Specifically, Glassdoor provides ratings, reviews, salary info, and interview information. For its ratings, Glassdoor provides company ratings on a 1-5 scale for the following dimensions: career opportunities, communication, compensation and benefits, employee morale, recognition and feedback, senior leadership, work/life balance, fairness and respect, overall, and percent of CEO approval. For its reviews, Glassdoor provides individual free text entries regarding “pros,” “cons,” and advice to senior management. For its salaries information, Glassdoor provides salary ranges and average salaries. Regarding interviews, Glassdoor provides an overall difficulty rating (1-5 scale), overall experience (% selecting positive, neutral, or negative), and individual entries for difficulty, experience (positive, neutral, or negative), length of time for interview process, free text description of process/experience, and free text list of interview questions. Another example approach is to generate categorized lists. For example, CNN/Fortune/Money puts out an annual “100 Best Companies to Work For” list. In addition to the full listing, subsets of the list are available ranking these top 100 companies along the following dimensions: location (e.g., by state), top companies (e.g., by size, job growth, low turnover, no layoffs, women, and minorities), big pay (e.g., salaried and hourly employees), and best perks (e.g., health care, child care, work-life balance, telecommuting, and sabbaticals). A third approach is to publish a career guide. Vault.com, for example, provides guides on top employers in various industries (e.g., legal, consulting, banking, and internet). These contain industry overviews as well as company profiles, which summarize input from employee surveys and other input on the culture and the hiring process.

While these approaches can provide the job seeker with additional information, they (either individually or in aggregate) do not enable the job seeker to base a job or employer search on particular cultural elements. The current model either requires a job seeker to first identify one or more companies (e.g., by name), and then look at a slew of commentary on the culture, or provides the job seeker with a very limited list of “top” providers in a given realm, as determined by the content provider. Thus, the current approaches do not provide an efficient way for the job seeker to search for a company that fits the seeker's desired cultural traits.

### SUMMARY OF THE INVENTION

Aspects of the present invention provide an efficient way for the job seeker to search for a company that fits the seeker's desired cultural traits by enabling the job seeker to identify key traits sought after in a prospective employer, and to use those traits to focus the job search. Thus, the seeker is able to use a formal framework for assessing a company's culture (vs. a series of unconnected comments that the end user must interpret), has access to a more-comprehensive, rather than selective, listing of companies that meet certain criteria (vs. “top 100” type lists), can identify traits that are the most and least relevant to a company's culture (vs. a 1-5 score), and can, as a result, see relative rankings of companies along various cultural dimensions.

One example embodiment of the present invention is a computer-implemented method of collecting and providing information regarding company culture. According to the example method, information from multiple individuals regarding cultural traits of companies at which the individuals have been employed is collected through disparate channels. Then, for at least one of the individuals, one or more companies at which the individual has been employed is identified based on information obtained through an employee referral system or obtained through a social networking account of the individual. The collected information is compiled in a manner associating certain cultural traits with corresponding companies based on the identification of the one or more companies. This compiled information is then provided in a format suitable for automated searching based on cultural traits.

Examples of cultural traits include information regarding perks, continued learning, work/life balance, creativity, freedom, recognition, family friendliness, mentors, social events, pet friendliness, and female leaders at the companies. In addition to collecting information regarding cultural traits, some embodiments may also prompt the individuals to specify sentiments regarding a company at which they are currently employed. The sentiments may be compiled in a manner associating the sentiments with corresponding companies, and can be provided in a format suitable for display. These sentiments can be collected over a given period of time and an indication of how the sentiments trend over the time period may be generated and presented.

In some embodiments identification of a company through an employee referral system includes identifying a company that initiated an evaluation to be completed by the individual, and in other embodiments identification of a company through a social networking account includes accessing an application programming interface of the social networking account. Companies may also be identified based on responses to surveys completed by other individuals. Some embodiments may further collect information by analyzing free-form text entered by the individuals.

When allowing an individual to search for companies based on cultural traits, certain embodiments may accept cultural trait indicators as part of a search request, and determine, for example, for each company in the compiled information, which of the indicated traits are applicable to the company, which of the indicated traits are not applicable to the company, and traits not indicated and that are applicable to the company. Weighted values may be assigned to the companies, and prioritized results may then be provided in response to the search request. The results may also be supplemented with firmographic information along with the cultural trait information.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a screenshot illustrating a search request input page of an example embodiment of the present invention.

FIG. 2 is a flow diagram illustrating a computer-implemented method of collecting and providing information regarding company culture, according to an example embodiment of the present invention.

FIGS. 3A-3C are detailed flow diagrams illustrating a computer-implemented method of collecting and providing information regarding company culture, according to an example embodiment of the present invention.

FIG. 4 is a block diagram illustrating a system for collecting and providing information regarding company culture, according to an example embodiment of the present invention.

FIG. 5 is a schematic view of a computer network in which the example embodiments disclosed herein may operate.

FIG. 6 is a block diagram of a computer node/device in the network of FIG. 5.

### DETAILED DESCRIPTION OF THE INVENTION

A description of example embodiments of the invention follows.

When job seekers search for employment opportunities, they typically begin by looking for objective criteria, such as a job title, and deciding whether to apply for an opportunity based on additional details, such as the description of responsibilities or salary range, if available. Similarly, when employers search for candidates, they also begin with objective criteria, such as educational background, years of experience, or work history. In both cases, the job seeker's ability to mesh with and thrive in an organization (the “fit” or “cultural fit” as used herein) takes a back seat (i.e., is a non-factor). However, many argue that fit has become the single most important factor for both sides of the equation, even more important than technical skills or experience. As we move to flatter organizations, more team and project work, and increasingly collaborative work environments, finding people who get along with others and fit into corporate culture are essential to success. Employees that fit with a company keep harmony, build community, and create trust, which are all important ingredients for success in innovative global and competitive environments.

The same holds true for the job seeker's concerns about finding an opportunity where he or she can achieve success and satisfaction. The problems with the established approaches are at least three-fold: (1) both the job seeker and the employer must invest in the application and interview process before even being able to assess a potential fit, (2) during this process, both sides are in “selling” mode, making it difficult to get a clear sense of the potential fit, and (3) for the job seeker, the sources of information on the company's culture are limited to company contacts involved in the hiring process and personal connections. Thus, while there are countless mechanisms of bringing companies and job seekers together, including thousands of career sites and job boards, none have yet succeeded in bringing the parties together on the basis of fit, rather than or in addition to experience or technical skills. The lack of an appropriate fit between new hires and their employers causes a great deal of early turnover. This imposes heavy costs on all parties. An organization incurs the expense of recruiting and training a replacement, lost productivity during the vacancy and ramp-up period, and potentially detrimental effects on the existing organization. While some hires may not be a good fit, they may, nonetheless, remain with the organization, hampering output, team effectiveness, and morale. Meanwhile, the individual in question suffers from a lack of development, forgone opportunities, and dissatisfaction. Many organizations attempt to preempt these tangible and intangible costs with a rigorous screening process. Casting a wider net in the hopes of attracting better fit candidates can actually have the opposite effect, as recruiters often find themselves awash in unsuitable applicants. Thus, there is an opportunity to help job seekers and organizations come together with a primary focus on cultural fit.

The principles of the present invention focus on a systematic approach to defining company culture by employing unique qualities or traits that define workplace culture, organized in a framework honed through extensive primary and secondary research. Embodiments of the present invention provide a mechanism for job seekers to search for potential employers and employment opportunities using, among other criteria, specific cultural elements that best align with the job seekers' values and work styles. To pinpoint specific areas where an individual's values, preferences, and work styles may or may not align with those of a company, embodiments of the present invention contain a framework of cultural traits that can be used in assessing an alignment or fit. These traits may encapsulate a range of topics, including compensation and benefits, diversity, lifestyle, work environment, and more.

Embodiments of the present invention collect and compile data on companies from multiple sources, such as for example, job seekers, verified current employees of an organization, and the general public. In some embodiments, individual contributors select which company/companies to evaluate by searching within a listing. In other embodiments, data from a contributor's social network profile may be used to identify current or previous employers whom the contributor can evaluate. In still other embodiments, a company representative (e.g., a Human Resources employee or a hiring manager) may request colleagues to submit evaluations of their current employers (for example, as part of an employee referral program).

To make this information available to users, embodiments of the present invention enable users to search for companies that possess a certain cultural trait or traits (e.g., work/life balance). Companies meeting the specified traits can then be identified and presented in a prioritized (ordered) list. In addition to displaying the search results, the most relevant cultural traits may also be displayed alongside job descriptions (e.g., to job seekers searching for particular job opportunities). A graphical image (data visualization) of feedback about a company may also be provided in a way that provides a visual and immediate summary of the feedback a company has received.

Embodiments of the invention may capture data on specific companies by several means, for example, an employee referral system, surveys open to members of the system's community, and targeted, exclusive surveys. Those individuals providing the data, or “contributors,” may include both current and former employees of a given company. A job seeker may interact with the system online, in a manner typical of consumer websites. For example, a job seeker may enter specific search criteria, which may be firmographic (e.g., company size), opportunity-specific (e.g., job title), or culture-specific, using the system's unique traits. The system may then run an algorithm to process the user's search request. To evaluate the cultural elements, the algorithm can evaluate the search criteria against the data in the system's company database, taking in to consideration data elements that include traits indicated as applicable to a company, traits indicated as not applicable to the company, and traits not selected with regard to the company. The algorithm may then assign certain weights to the type and frequency of each data point. In addition, the algorithm can employ text-mining techniques to identify the most applicable company descriptors as entered in free text by the data contributors, and can incorporate additional data from questionnaires on overall views and recommendations about the company. The algorithm may then identify the source of each data point and assign certain values accordingly. As a whole, the algorithm provides a mechanism for incorporating each of these distinct components into a calculation and prioritization of the most relevant search results to present to the end user. Afterwards, the system can present to the end user a prioritized list of results according to the search parameters entered by the user, and may use an arrangement of unique graphical images, text, and other data visualization to provide the user with detailed and unique insight into the company's culture.

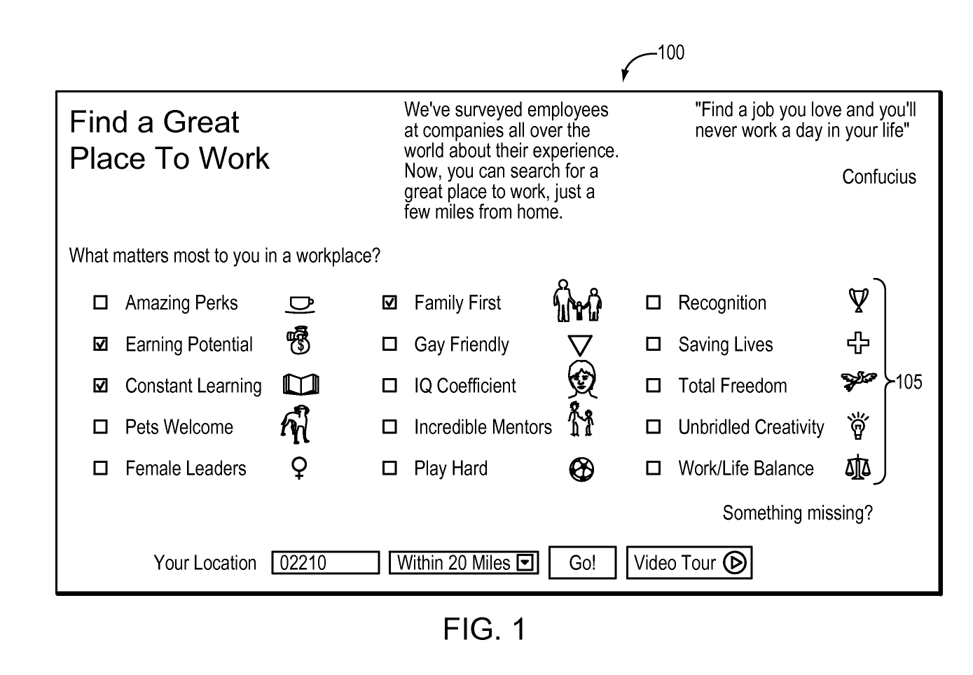

FIG. 1 is a screenshot 100 illustrating a search request input page of an example embodiment of the present invention. As shown, example cultural traits 105 that may be specified as part of a search request may include perks, work/life balance, creativity, freedom, recognition, family, mentors, and pets, to list a few.

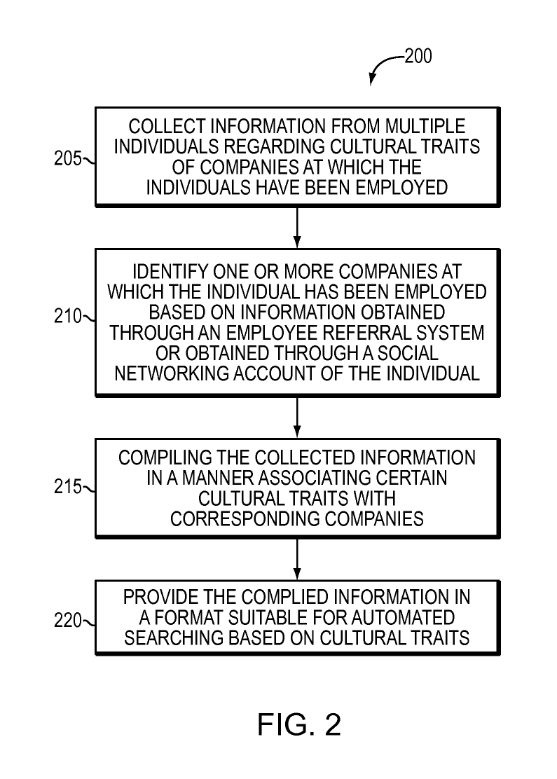

FIG. 2 is a flow diagram illustrating a computer-implemented method 200 of collecting and providing information regarding company culture, according to an example embodiment of the present invention. According to the method 200, information from multiple individuals regarding cultural traits of companies at which the individuals have been employed is collected (205) through disparate channels. Then, for at least one of the individuals, one or more companies at which the individual has been employed is identified (210) based on information obtained through an employee referral system or obtained through a social networking account of the individual. The collected information is compiled (215) in a manner associating certain cultural traits with corresponding companies based on the identification of the one or more companies. This compiled information is then provided (220) in a format suitable for automated searching based on cultural traits.

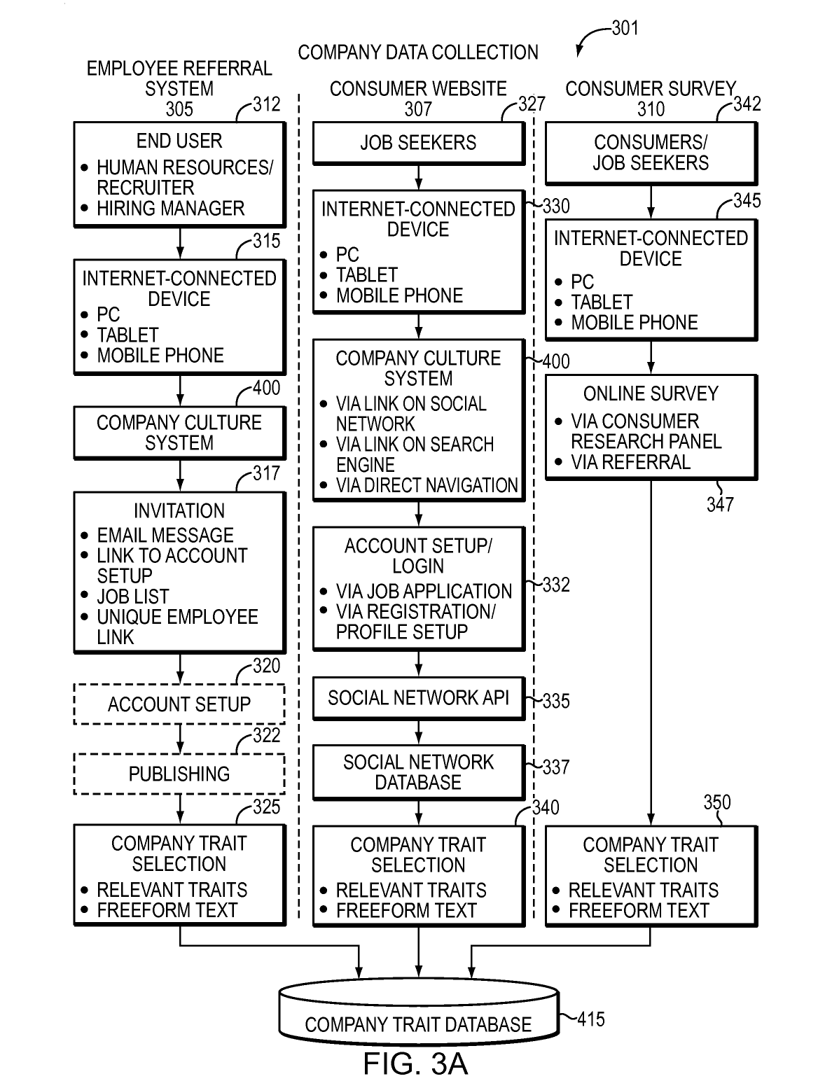

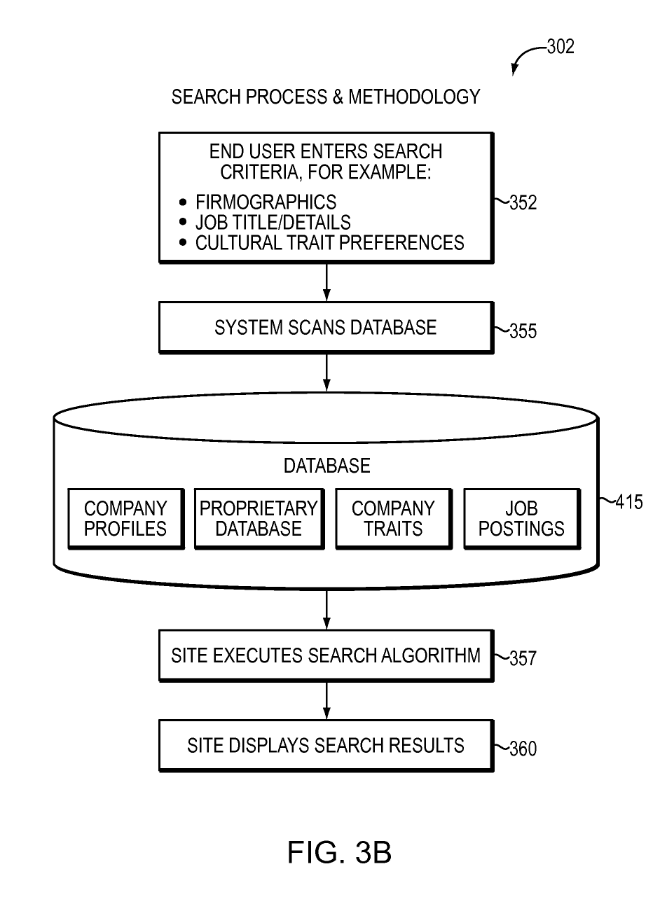

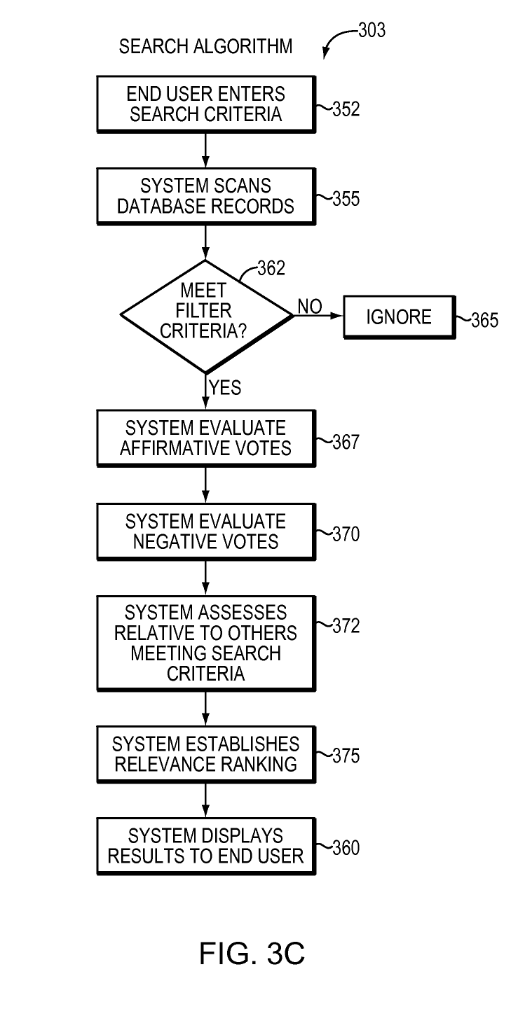

FIGS. 3A-3C are detailed flow diagrams illustrating a computer-implemented method 301, 302, 303 of collecting and providing information regarding company culture, according to an example embodiment of the present invention.

FIG. 3A provides an example overview 301 of how company-specific data regarding cultural traits may be collected from various sources. Flow 305 represents data being collected through an employee referral system. Flow 307 represents a consumer-facing website gathering information from job seekers and consumers. Flow 310 represents data collection from a panel of consumers by means of an electronic survey.

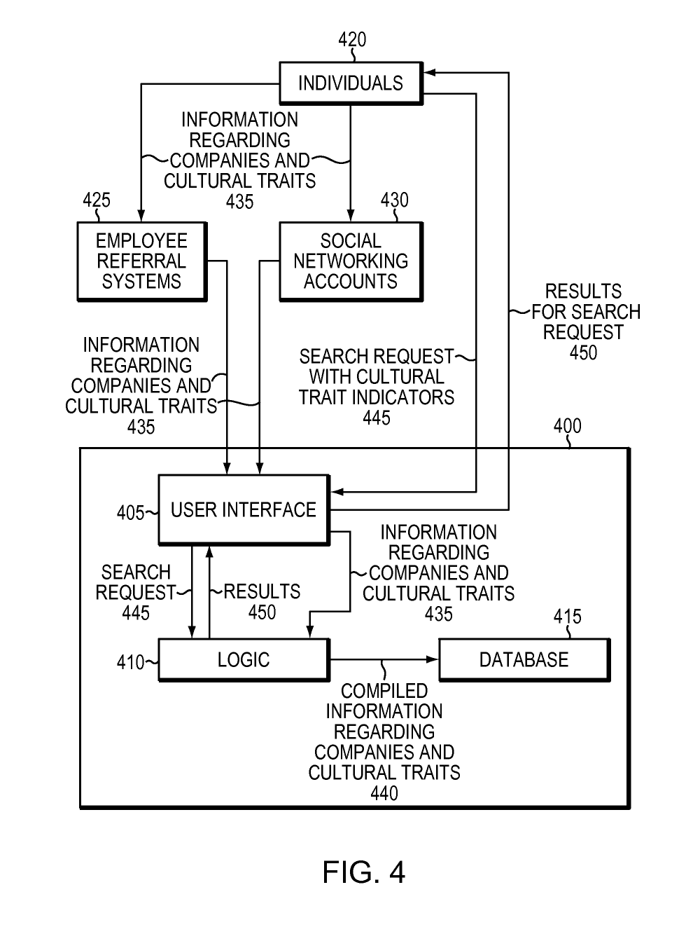

Flow 305 begins with an end user (e.g., human resources manager, recruiter, or hiring manager) 312 using an Internet-connected device (e.g., PC, tablet, or mobile phone) 315 to access a system 400 (see FIG. 4) for collecting information regarding company culture. The system 400 may send an invitation 317 to setup an account and publish the information 320, 322. Information regarding company culture may then be collected (325) by, for example, specifying specific traits for a company or by analyzing free-form text. That information is then stored in a company trait database 415 (see FIG. 4).

Flow 307 begins with a job seeker 327 using an Internet-connected device (e.g., PC, tablet, or mobile phone) 330 to access a system 400 (see FIG. 4) for collecting information regarding company culture via, for example, a social network application, search engine, or direct navigation. The job seeker 327 creates an account or logs-in to an existing account (332) where information regarding company culture may be collected (340) via a social network application programming interface (API) 335 or database 337, and stored in the company trait database 415.

Flow 310 begins with a job seeker or general consumer 342 using an Internet-connected device (e.g., PC, tablet, or mobile phone) 345 to complete an online survey 347 through which information regarding company culture is collected (350) and then stored in the company trait database 415.

FIG. 3B illustrates an example process 302 for enabling users to use cultural traits in search criteria and displaying the results of that search. According to the example process 302, an end user enters search criteria (352) including cultural trait preferences, and may also include other search criteria, such as firmographic information, job, title, and job details. The process 302 then accesses (355) the database 415 and executes a search algorithm (357) to determine search results, for example, by determining which of the specified cultural trait preferences are applicable to the company, which are not applicable, and other traits that were not indicated by the end user, but that are applicable to the company. Weights may be assigned to each company and the system then displays (360) the search results to the user.

FIG. 3C provides an example overview 303 of how the search algorithm 357 executes a search based on the user-entered criteria. After the end user enters search criteria (352) and the database 415 is accessed (355), the example process 303 determines if a particular record of the database meets one of the criteria (362). If not, the record is ignored (365). If, on the other hand, the record meets one of the criteria, then the system evaluates affirmative and negative values regarding the specified cultural traits (367, 370), and assesses the record with respect to other records also meeting the search criteria to establish a relevance ranking (372, 375). The results are then displayed to the end user (360).

FIG. 4 is a block diagram illustrating a system 400 for collecting and providing information regarding company culture, according to an example embodiment of the present invention. The system 400 includes a user interface 405 that collects, through disparate channels, information 435 from multiple individuals 420 regarding cultural traits of companies at which the individuals 420 have been employed, and that obtains any information regarding the companies through employee referral systems 425 or social networking accounts 430 of the individuals 420. The system 400 further includes logic 410 that identifies, for at least one of the multiple individuals 420, one or more companies at which the individual has been employed based on the information obtained through an employee referral system 425 or obtained through a social networking account 430 of the individual. The logic 410, thus, provides an association of cultural traits with companies. In addition, the system includes a database 415 storing the collected information 440 in a manner associating certain cultural traits with corresponding companies and in a format suitable for automated searching based on cultural traits.

In some embodiments, the system 400 may accept cultural trait indicators as part of a search request 445, which the logic 410 can use to determine search results, for example, by determining for each company of the compiled information 440, which of the indicated traits are applicable to the company, which of the indicated traits are not applicable to the company, and traits not indicated and that are applicable to the company, and by assigning a weighted value to the company based on the determined information. In such embodiments, the user interface 405 can provide prioritized results 450 in response to the search request 445 based on the values assigned to each company.

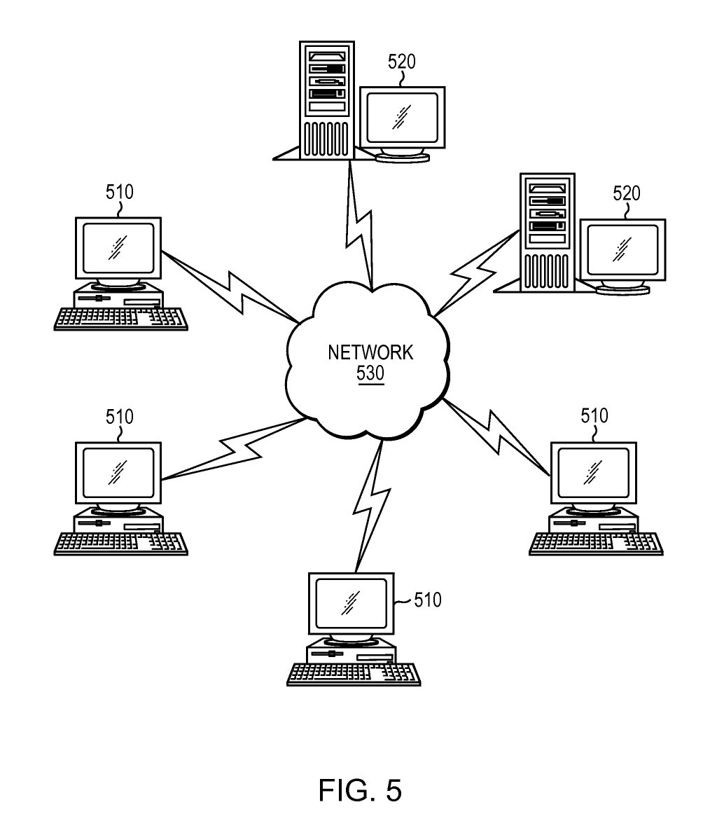

FIG. 5 is a schematic view of a computer network in which embodiments of the present invention may operate. Client devices 510 and server devices 520 provide processing, storage, and input/output devices executing application programs and the like. Client devices 510 can also be linked through a communications network 530 to other computing devices, including other client devices 510 and server devices 520. The communications network 530 may be part of a remote access network, a global network (e.g., the Internet), a worldwide collection of computing devices, local area or wide area networks, and gateways that currently use respective protocols (TCP/IP, Bluetooth, etc.) to communicate with one another. Other electronic device/computer network architectures are also suitable.

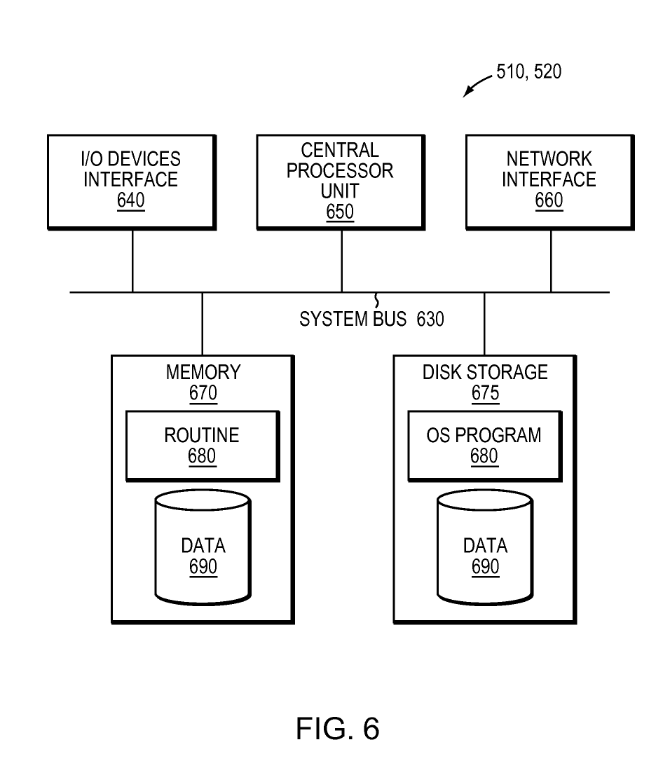

FIG. 6 is a block diagram of a computer node/device 510, 520 in the network of FIG. 5. Each device 510, 520 contains a system bus 630, where a bus is a set of hardware lines used for data transfer among the components of a device or processing system. The bus 630 is essentially a shared conduit that connects different elements of a device (e.g., processor, disk storage, memory, input/output ports, network ports, etc.) that enables the transfer of information between the elements. Attached to the system bus 630 is an I/O device interface 640 for connecting various input and output devices (e.g., keyboard, mouse, displays, printers, speakers, etc.) to the device 510, 520. A network interface 660 allows the device to connect to various other devices attached to a network (e.g., network 530 of FIG. 5). Memory 670 provides volatile storage for computer software instructions 680 and data 690 used to implement an embodiment of the present invention (e.g., user interface 405, logic 410, and database 415 of FIG. 4, and supporting code for performing the functions and processes 200, 301, 302, and 303 detailed above in FIGS. 2-3C). Disk storage 675 provides non-volatile storage for computer software instructions 680 and data 690 used to implement the methods and systems disclosed herein. Central processor unit 650 is also attached to the system bus 630 and provides for the execution of computer instructions.

In one embodiment, the processor routines 680 and data 690 are a computer program product (generally referenced 680), including a computer readable medium (e.g., a removable storage medium such as one or more DVD-ROM's, CD-ROM's, diskettes, tapes, or a portal server medium, etc.) that provides at least a portion of the software instructions for the invention system. Computer program product 680 can be installed by any suitable software installation procedure, as is well known in the art. In another embodiment, at least a portion of the software instructions may also be downloaded over a cable, communication and/or wireless connection.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method of collecting and providing information regarding company culture, the method comprising:
collecting, through disparate channels, information from multiple individuals regarding cultural traits of companies at which the individuals have been employed;
for at least one of the multiple individuals, identifying one or more companies at which the individual has been employed based on information obtained through an employee referral system or obtained through a social networking account of the individual;
compiling the collected information in a manner associating certain cultural traits with corresponding companies, said identifying one or more companies providing an association of at least one cultural trait with at least one company; and
providing the compiled information in a format suitable for automated searching based on cultural traits.

2. A computer-implemented method as in claim 1 wherein the cultural traits include information regarding any of perks, continued learning, work/life balance, creativity, freedom, recognition, family friendliness, mentors, social events, pet friendliness, and female leaders at the companies.

3. A computer-implemented method as in claim 1 wherein identifying one or more companies at which the individual has been employed based on information obtained through an employee referral system includes identifying a company that initiated an evaluation to be completed by the individual.

4. A computer-implemented method as in claim 1 wherein identifying one or more companies at which the individual has been employed based on information obtained through a social networking account of the individual includes accessing an application programming interface of the social networking account.

5. A computer-implemented method as in claim 1 further comprising identifying one or more companies at which another individual has been employed based on responses to a survey completed by the other individual.

6. A computer-implemented method as in claim 1 wherein collecting information includes identifying cultural traits for a company by analyzing free-form text entered by the individuals.

7. A computer-implemented method as in claim 1 further comprising:
accepting cultural trait indicators as part of a search request;
determining, for each company of the compiled information, which of the indicated traits are applicable to the company, which of the indicated traits are not applicable to the company, and traits not indicated and that are applicable to the company;
assigning a weighted value to the company based on the determined information;
providing prioritized results in response to the search request based on the values assigned to each company.

8. A computer-implemented method as in claim 7 further comprising providing firmographic information along with the results containing cultural trait information.

9. A computer-implemented method as in claim 1 further comprising:
prompting the individuals to specify sentiments regarding companies at which they are currently employed;
compiling sentiments received from the individuals in a manner associating the sentiments with corresponding companies; and
providing the compiled sentiments in a format suitable for display.

10. A computer-implemented method as in claim 9 further comprising:
compiling sentiments received from the individuals in a manner associating the sentiments with corresponding companies over a given period of time; and
generating, for a given company, an indication of how the sentiments corresponding to the company trend over the period of time.

11. A system for collecting and providing information regarding company culture, the method comprising:
a user interface configured to collect, through disparate channels, information from multiple individuals regarding cultural traits of companies at which the individuals have been employed, and further configured to obtain any information regarding the companies through employee referral systems or social networking accounts of the individuals;
logic configured to identify, for at least one of the multiple individuals, one or more companies at which the individual has been employed based on the information obtained through an employee referral system or obtained through a social networking account of the individual, said logic providing an association of at least one cultural trait with at least one company; and
a database configured to store the collected information in a manner associating certain cultural traits with corresponding companies and in a format suitable for automated searching based on cultural traits.

12. A system as in claim 11 wherein the cultural traits include information regarding any of perks, continued learning, work/life balance, creativity, freedom, recognition, family friendliness, mentors, social events, pet friendliness, and female leaders at the companies.

13. A system as in claim 11 wherein the logic is further configured to identify a company that initiated an evaluation to be completed by the individual.

14. A system as in claim 11 wherein the logic is further configured to access an application programming interface of the social networking account.

15. A system as in claim 11 further the logic is further configured to identify one or more companies at which another individual has been employed based on responses to a survey completed by the other individual.

16. A system as in claim 11 wherein the logic is further configured to identify cultural traits for a company by analyzing free-form text entered by the individuals.

17. A system as in claim 11 wherein the user interface is further configured to accept cultural trait indicators as part of a search request, wherein the logic is further configured to determine, for each company of the compiled information, which of the indicated traits are applicable to the company, which of the indicated traits are not applicable to the company, and traits not indicated and that are applicable to the company, and assign a weighted value to the company based on the determined information, and wherein the user interface is further configured to provide prioritized results in response to the search request based on the values assigned to each company.

18. A system as in claim 17 wherein the user interface is further configured to provide firmographic information along with the results containing cultural trait information.

19. A system as in claim 11 wherein the user interface is further configured to prompt the individuals to specify sentiments regarding companies at which they are currently employed, wherein the database is further configured to store the sentiments in a manner associating the sentiments with corresponding companies, and wherein the user interface is further configured to provide the stored sentiments in a format suitable for display.

20. A system as in claim 19 wherein the logic is further configured to compile the sentiments received from the individuals over a given period of time and generate, for a given company, an indication of how the sentiments corresponding to the company trend over the period of time.

21. A non-transitory computer readable medium having computer readable program codes embodied therein for collecting and providing information regarding company culture, the computer readable medium program codes including instructions that, when executed by a processor, cause the processor to:
collect, through disparate channels, information from multiple individuals regarding cultural traits of companies at which the individuals have been employed;
for at least one of the multiple individuals, identify one or more companies at which the individual has been employed based on information obtained through an employee referral system or obtained through a social networking account of the individual;
compile the collected information in a manner associating certain cultural traits with corresponding companies, said identification of one or more companies providing an association of at least one cultural trait with at least one company; and
provide the compiled information in a format suitable for automated searching based on cultural traits.

22. A non-transitory computer readable medium as in claim 21 wherein the cultural traits include information regarding any of perks, continued learning, work/life balance, creativity, freedom, recognition, family friendliness, mentors, social events, pet friendliness, and female leaders at the companies.

23. A non-transitory computer readable medium as in claim 21 wherein the instructions further cause the processor to identify a company that initiated an evaluation to be completed by the individual.

24. A non-transitory computer readable medium as in claim 21 wherein the instructions further cause the processor to access an application programming interface of the social networking account.

25. A non-transitory computer readable medium as in claim 21 wherein the instructions further cause the processor to identify one or more companies at which another individual has been employed based on responses to a survey completed by the other individual.

26. A non-transitory computer readable medium as in claim 21 wherein the instructions further cause the processor to identify cultural traits for a company by analyzing free-form text entered by the individuals.

27. A non-transitory computer readable medium as in claim 21 wherein the instructions further cause the processor to:
accept cultural trait indicators as part of a search request;
determine, for each company of the compiled information, which of the indicated traits are applicable to the company, which of the indicated traits are not applicable to the company, and traits not indicated and that are applicable to the company;
assign a weighted value to the company based on the determined information;
provide prioritized results in response to the search request based on the values assigned to each company.

28. A non-transitory computer readable medium as in claim 27 wherein the instructions further cause the processor to providing firmographic information along with the results containing cultural trait information.

29. A non-transitory computer readable medium as in claim 21 wherein the instructions further cause the processor to:
prompt the individuals to specify sentiments regarding companies at which they are currently employed;
compile sentiments received from the individuals in a manner associating the sentiments with corresponding companies; and
provide the compiled sentiments in a format suitable for display.

30. A non-transitory computer readable medium as in claim 29 wherein the instructions further cause the processor to:
compile sentiments received from the individuals in a manner associating the sentiments with corresponding companies over a given period of time; and
generate, for a given company, an indication of how the sentiments corresponding to the company trend over the period of time.
